(19) United States
(12) Patent Application Publication
(10) Pub. No.: US 2016/0247237 A1
(43) Pub. Date: Aug. 25, 2016

(54) POSITION-BASED BUDGET COMMUNICATION APPARATUS FOR USE IN POSITION-BASED BUDGETING SYSTEMS

(71) Applicant: BANK OF AMERICA CORPORATION, CHARLOTTE, NC (US)

(72) Inventors: David M. Grigg, Rock Hill, SC (US); Elizabeth S. Votaw, Potomac, MD (US)

(21) Appl. No.: 14/629,364

(22) Filed: Feb. 23, 2015

(51) Int. Cl. G06Q 40/00

(52) U.S. Cl. CPC G06Q 40/12

(57) ABSTRACT

Various embodiments include a position-based budget communication apparatus for use in a position-based budgeting system, whereby the apparatus communicates budget information in real-time based on geographical positioning determinations and consumer preferences. In an exemplary embodiment, the apparatus determines location information about an interaction between a consumer's mobile device and an electronic device located proximate to a merchant area and uses the location information to instantaneously determine that the consumer's location is within a predetermined distance range from the merchant associated with the merchant area. The apparatus then electronically retrieves budget information associated with the consumer and the merchant such as an amount of money that the consumer has spent at the merchant within a particular period of time and electronically communicates at least a portion of the budget information to the consumer's mobile device based on consumer preference data.

### FIELD OF INVENTION

In general, embodiments of the invention relate to position-based budgeting systems and, more particularly, an apparatus for communicating position-based budgeting information to a consumer in real-time based on geographical positioning determinations and consumer preferences.

### BACKGROUND

Many financial institutions provide customers an opportunity to view their account information using their mobile devices or via an online setting in response to requests from the customers (e.g., using a mobile-device-based or web-based application on the mobile device). Customers often repeatedly view their account information in order to keep track of spending and monitor budgets. Consequently, some financial institutions and third parties also provide online budget assistance tools. However, these tools typically provide budget information to customers only in response to requests from customers to view the information. If the customer forgets (or is unable) to check his or her budget information and/or his or her account balance(s) before making a purchase, the customer may inadvertently spend more than the customer has budgeted. Therefore, a system for providing improved, proactive, and real-time budget information is needed.

### BRIEF SUMMARY

The following presents a simplified summary of one or more embodiments of the invention in order to provide a basic understanding of such embodiments. This summary is not an extensive overview of all contemplated embodiments and is not intended to identify key or critical elements of all embodiments or delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., systems, computer program products, and/or other devices), methods, or a combination of the foregoing for providing proactive and real-time position-based budget information. For example, some embodiments of the invention provide a system that uses a consumer's mobile phone to track the consumer's location relative to one or more merchants. When the consumer is proximate a particular merchant, the system automatically presents, via the mobile phone, budget information related to the consumer and the merchant. For example, in some embodiments, the system informs the consumer of the amount of money that the consumer has spent at the nearby merchant over some defined period of time. In other embodiments, the system informs the consumer of the amount of money left in a consumer-defined budget for a product type associated with the nearby merchant. In still other embodiments, when the consumer visits or passes by a merchant, the system automatically notifies the consumer, via the consumer's mobile phone, about how much money the consumer has available in gift cards that can be used to pay the merchant.

In particular, according to various embodiments, a computer-implemented method includes: (1) receiving location information for a consumer's mobile device; (2) identifying a merchant that is located within a particular distance range of the consumer's mobile device; (3) retrieving, from a memory, budget information associated with the consumer and the merchant; and (4) communicating at least a portion of the budget information to the consumer's mobile device, the at least a portion of the budget information being displayable thereon. In some embodiments, the budget information includes information about an amount of money available on a gift card that is held by the consumer and can be used at the merchant, and in other embodiments, the budget information includes information about an amount of money that the consumer has spent at the merchant within a particular period of time.

In certain embodiments, retrieving budget information associated with the consumer and the merchant includes: (1) identifying a category associated with the merchant; and (2) retrieving, from the memory, budget information associated with a budget, the budget being associated with the category. In some embodiments, the budget includes a consumer-defined amount of money available to be spent within the category over a particular period of time, and the budget information includes a balance associated with the budget.

In addition, according to various embodiments, the category may include a product type or a merchant type. According to certain embodiments, identifying the merchant type further includes: (1) identifying a name of the merchant; and (2) retrieving a merchant type associated with the name of the merchant from a merchant type list. In one embodiment in which the merchant type corresponds to a merchant category code, the name of the merchant may be identified from a list of one or more merchant names associated with the merchant category code.

According to other various embodiments, retrieving budget information associated with the consumer and the merchant includes: (1) identifying a category associated with the merchant; and (2) retrieving, from the memory, budget information associated with a budget account, the budget account being associated with the category. In certain embodiments, the budget information includes a balance associated with the budget account, and in one embodiment, balance information associated with a spending account, wherein the spending account is associated with the merchant. For example, in one embodiment, the spending account corresponds to a gift card issued by the merchant, and the balance information includes a spending balance for the gift card.

In addition, according to various embodiments, receiving location information for the consumer's mobile device includes receiving location information from a global positioning system or receiving information about interaction between the consumer's mobile device and an electronic device located proximate the merchant. In addition, according to various embodiments, the particular distance range is between 0 feet and about 200 feet, less than about 50 feet, or defined by the consumer. In one particular embodiment, the particular distance range is zero, and identifying the merchant that is located within the particular distance range of the consumer's mobile device includes identifying when the consumer's mobile device enters the merchant's facility.

Furthermore, according to various embodiments, the method also includes: (1) identifying at least a first merchant and a second merchant that are located within a particular distance range of the consumer's mobile device; (2) retrieving, from a memory, first budget information associated with the first merchant and second budget information associated with the second merchant; (3) communicating information regarding existence of the first budget information and the second budget information to the consumer's mobile device; (4) in response to receiving a selection from the consumer's mobile device to view the first budget information, communicating at least a portion of the first budget information to the consumer's mobile device, the at least a portion of the first budget information being displayable thereon; and (5) in response to receiving a selection from the consumer's mobile device to view the second budget information, communicating at least a portion of the second budget information to the consumer's mobile device, the at least a portion of the second budget information being displayable thereon.

According to various embodiments, the an apparatus includes: (1) a positioning system configured to determine location information for a consumer's mobile device; (2) a computer system configured to: (a) use the location information to determine that the consumer's location is within a predetermined distance range from a merchant; and (b) retrieve, from a memory, budget information associated with the consumer and the merchant; and (3) a communication system configured to communicate at least a portion of the budget information to the consumer's mobile device, the at least a portion of the budget information being displayable thereon. According to certain embodiments, the budget information includes information about an amount of money available on a gift card that is held by the consumer and can be used at the merchant and/or information about an amount of money that the consumer has spent at the merchant within a particular period of time. In some embodiments, the computer system is configured to retrieve budget information associated with the consumer and the merchant by: (1) identifying a category associated with the merchant; and (2) retrieving, from the memory, budget information associated with a budget, the budget being associated with the category.

Other embodiments of the invention include a computer program product for a mobile commerce system. The computer program product includes at least one non-transitory computer-readable medium having computer-executable code portions embedded therein, and the computer-executable program code portions include: (1) a first executable portion configured for receiving location information for a consumer's mobile device; (2) a second executable portion configured for identifying a merchant that is located within a particular distance range of the consumer's mobile device; (3) a third executable portion configured for retrieving, from a memory, account information associated with a budget that relates to the merchant and the consumer; and (4) a fourth executable portion configured for communicating at least a portion of the account information to the consumer's mobile device, the at least a portion of the account information being displayable thereon.

### BRIEF DESCRIPTION OF THE FIGURES

Having thus described embodiments of the invention in general terms, reference will now be made to the accompanying drawings, wherein:

FIG. 1 provides a block diagram illustrating a position-based budgeting system and environment in accordance with an embodiment of the invention;

FIG. 2 provides a block diagram illustrating the consumer mobile device of FIG. 1 in more detail in accordance with an embodiment of the invention;

FIG. 3 provides a block diagram illustrating the financial management system of FIG. 1 in more detail in accordance with an embodiment of the invention;

FIG. 4 provides a block diagram illustrating the merchant system of FIG. 1 in more detail in accordance with an embodiment of the invention;

FIG. 5 provides a block diagram illustrating the budgeting system of FIG. 1 in more detail in accordance with an embodiment of the invention;

FIG. 6 provides a flow chart illustrating a position-based budgeting process in accordance with an embodiment of the invention;

FIG. 7 provides a flow chart illustrating a position-based budgeting process in accordance with another embodiment of the invention;

FIG. 8 provides a flow chart illustrating a process in accordance with another embodiment of the invention;

FIG. 9 illustrates an exemplary table listing merchant category codes and corresponding merchant types according to one embodiment of the invention;

FIG. 10 illustrates an exemplary table listing merchant names and corresponding budget categories according to one embodiment of the invention; and

FIG. 11 illustrates an exemplary table listing merchant types and corresponding budget accounts according to one embodiment of the invention.

### DETAILED DESCRIPTION OF VARIOUS EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

According to various embodiments of the invention, a position-based budgeting system uses the location of a consumer's mobile device relative to one or more merchants to determine relevant budget information to communicate to the consumer's mobile device. For example, when the consumer and his or her mobile device approach or enter a coffee shop, the budget account name and budget information (e.g., how much has been spent for the month and how much is left in the budget) associated with coffee shop purchases is displayed on the consumer's mobile device. Similarly, when the consumer and his or her mobile device approach or enter a grocery store, the budget account name and budget information associated with grocery store purchases is displayed on the consumer's mobile device. In addition, the system may also display gift card balances associated with a particular merchant when the consumer and his or her mobile device approach or enter the merchant's store. As such, embodiments of the present invention provide apparatuses (e.g., systems, computer program products, and/or other devices), methods, or a combination of the foregoing for providing real-time or substantially real-time budget information to a consumer's mobile device based at least in part on the location of the consumer relative to one or more merchants, which may assist the consumer in keeping his or her spending within budget.

### Mobile Commerce System and Environment

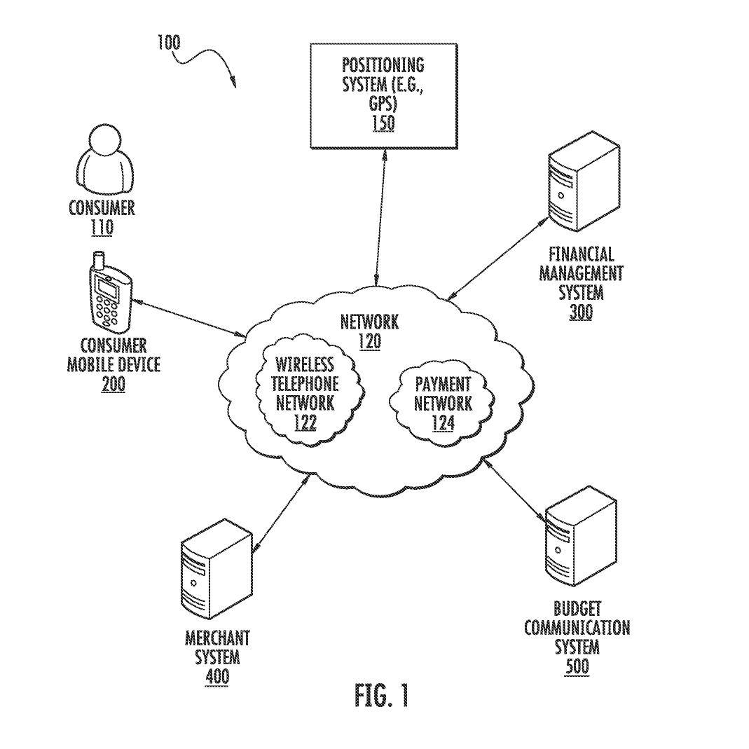

Referring now to the figures, FIG. 1 provides a block diagram illustrating a mobile commerce system and environment 100 in accordance with an embodiment of the invention. As illustrated, the system 100 generally includes a consumer 110, a network 120, a positioning system 150, a consumer mobile device 200, a financial management system 300, a merchant system 400, and a budget communication system 500. The consumer 110 may be any individual or entity with the potential to purchase products from a merchant. As used herein, the term “products” refers to goods, services, and/or the like. As used herein, the term “merchant” refers to any entity involved in advertising, promoting, offering, creating, manufacturing, selling, or otherwise providing one or more products to one or more consumers. For example, the merchant may be a manufacturer, retailer, wholesaler, advertiser, marketer, distributor, and/or the like.

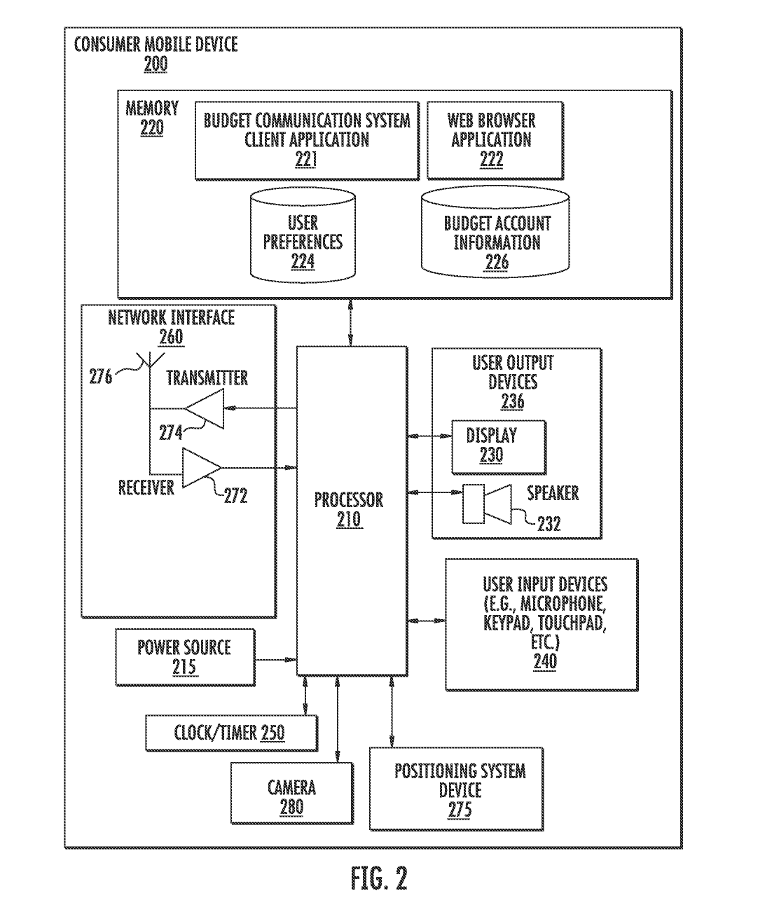

The consumer 110 has a mobile device 200, such as a mobile phone, personal digital assistant (PDA), personal navigation device, personal web-surfing device, or other personal/mobile computing device. Embodiments of the consumer mobile device 200 are described in greater detail in FIG. 2 and the accompanying description.

The network 120 may be any of one or more devices or connections communicably coupling two or more devices. For example, the network 120 may include a global area network, such as the Internet, a wide area network, a local area network, a wireless network, a wire-line network, one or more modems, one or more servers, one or more relay devices, one or more direct electrical connections, one or more satellites, and/or the like, or a combination thereof. As illustrated, in some embodiments, the network 120 includes a wireless telephone network 122, such as a cellular network or other mobile telephone/data network known in the art. As also illustrated, in some embodiments, the network 120 includes a payment network 124 for processing electronic or other payments and transferring money between banks and other entities. For example, the payment network 124 may include the networks of one or more banks or other well-known payment network providers such as Visa®, MasterCard®, American Express®, and/or the like.

According to various embodiments, the positioning system 150 may be the well-known Global Positioning System (GPS) or other systems for identifying precise geographical locations of individuals or devices or positions of individuals or devices relative to known objects or locations. For example, some embodiments of the invention include a positioning system that can identify the current latitude and longitude, and in some cases altitude, of the consumer's mobile device 200 using a sensor/transceiver in the consumer's mobile device 200 in conjunction with a satellite system and/or the wireless telephone network 122. In other embodiments, more local sensors/transceivers interact with sensors/transceivers of the consumer's mobile device 200 to determine if the consumer 110 is within a certain distance from a merchant and/or moving toward or away from the merchant. For example, in one embodiment of the invention, a merchant has sensors at its entrances that can communicate with consumer mobile devices 200 that have near field communication (NFC) capabilities and, thereby, determine when the consumer 110 possessing the consumer mobile device 200 enters or leaves the merchant's facility.

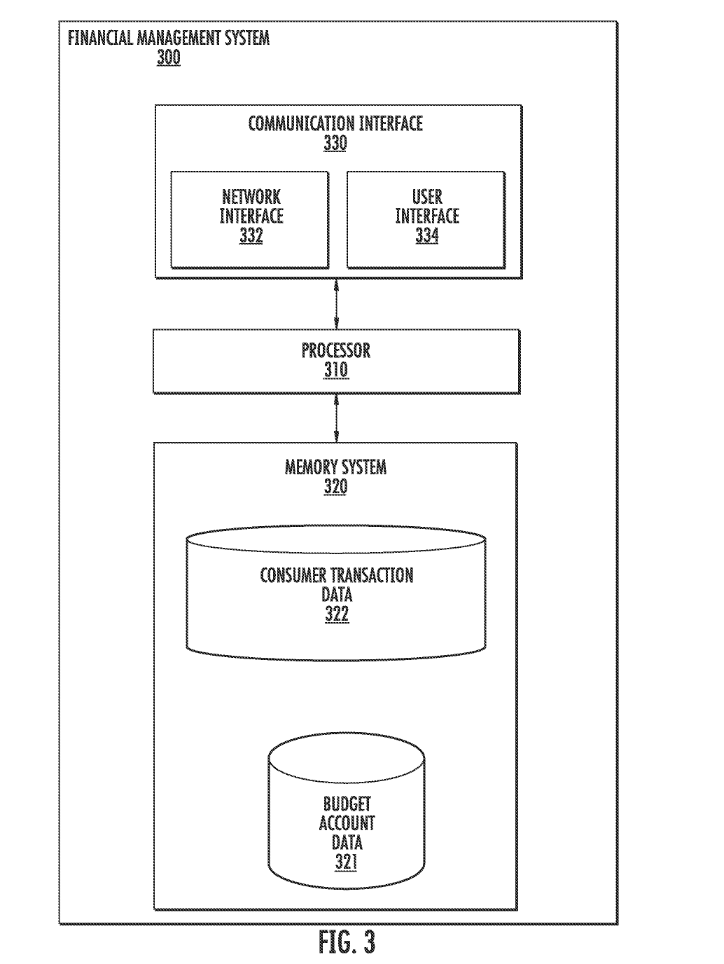

The financial management system 300 stores financial information for the consumer 110 and/or the merchant, including information about transactions between the consumer 110 and one or more merchants over a particular period of time and budget information for one or more budget accounts set up by the consumer 110. The budget accounts correspond with various spending categories (e.g., merchant types, product types) specified by the consumer. According to various embodiments, the budget information for each budget account includes, for example, a budget account name, an amount of money available to be spent within the spending category (e.g., spending balance), and credit and/or withdrawal rules associated therewith, etc. Embodiments of the financial management system 300 and budget information are described in greater detail in FIG. 3 and the accompanying description.

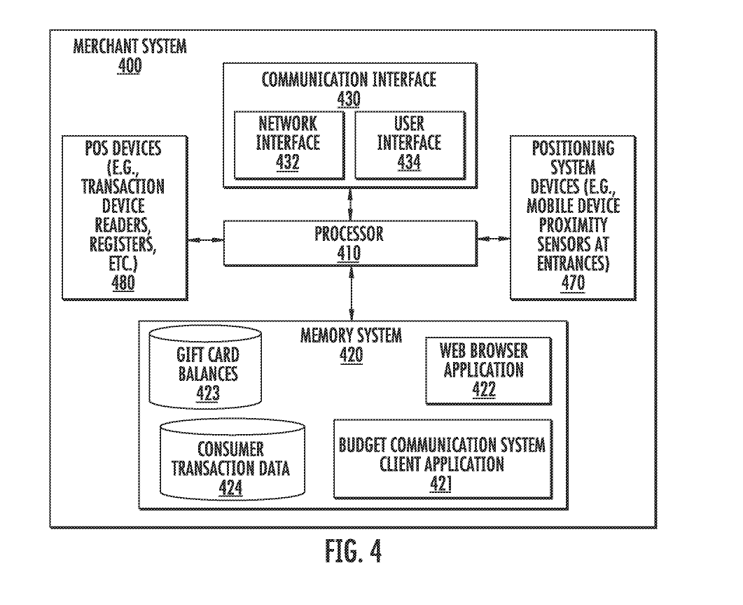

According to various embodiments, the merchant system 400 processes transactions between the consumer 110 and the merchant and allows the merchant to interact with the budget communication system 500. The merchant system 400 also stores balance information (e.g., amount of money available or spending balance) for gift cards or spending accounts issued to consumers for purchases made at the merchant's location(s). Embodiments of the merchant system 400 are described in greater detail in FIG. 4 and the accompanying description.

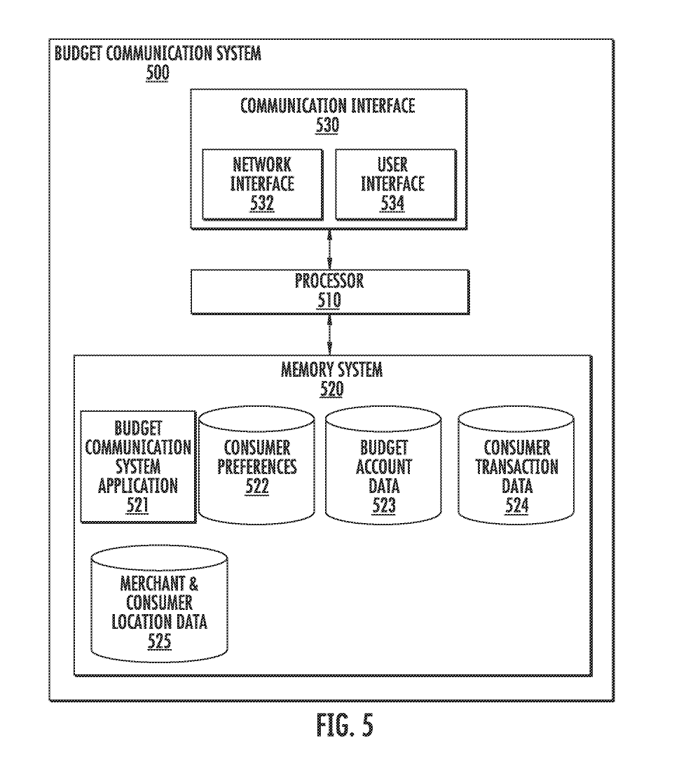

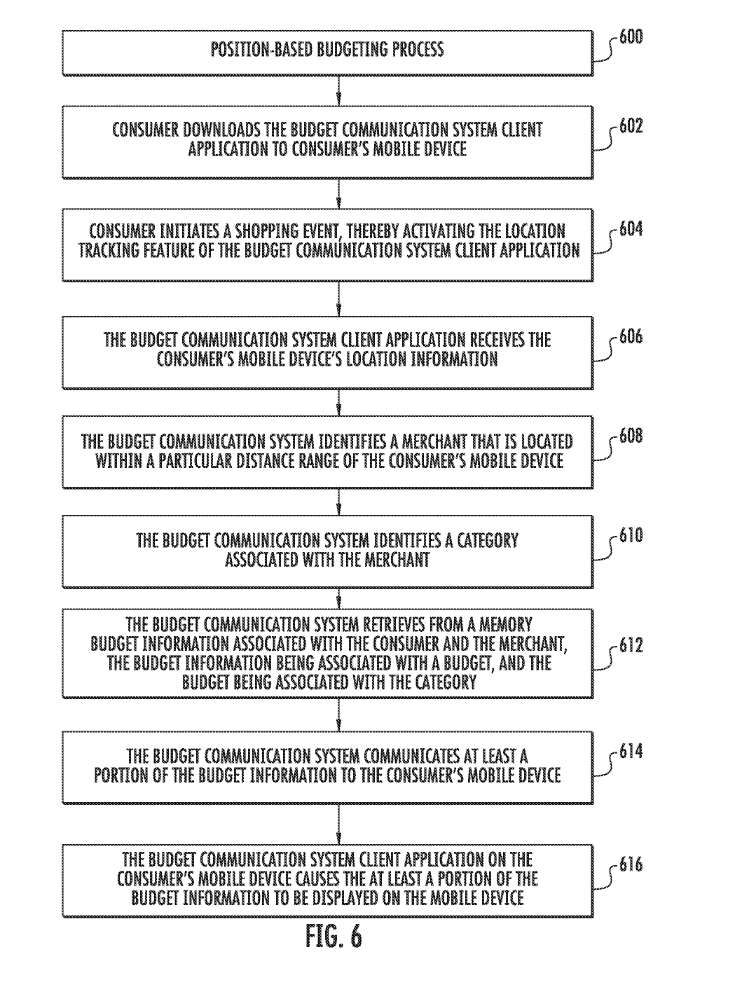

According to various embodiments, the budget communication system 500 provides relevant budget account, merchant purchasing trends, and/or merchant balance information to the mobile device 200 when the consumer 110 is near or entering the merchant's facility. Embodiments of the various processes, features, and functions managed by the budget communication system 500 are described below in FIGS. 6 through 8 and the accompanying descriptions. Embodiments of the budget communication system 500 are also described in greater detail in FIG. 5 and the accompanying description.

For example, as described in greater detail below, in one embodiment of the system 100, a consumer's location relative to one or more merchants is tracked using the positioning system 150 and the consumer's mobile device 200. The budget communication system 500 receives the position of the consumer's mobile device from the positioning system 150, identifies the type(s) of merchant(s) located near the consumer's mobile device 200, retrieves budget information related to each type of merchant identified, and communicates the retrieved budget information to the consumer's mobile device 200 for display thereon. In addition, according to one embodiment, the budget communication system 500 and/or the financial management system 300 determines trends in the consumer's shopping behavior based on information stored by the financial management system 300, and these trends are used to determine which of two or more merchants the consumer is more likely to be visiting at a particular time of the day, when, for example, there are two or more merchants located near the consumer's mobile device 200.

### Consumer Mobile Device

FIG. 2 provides a block diagram illustrating the consumer mobile device 200 of FIG. 1 in more detail in accordance with an embodiment of the invention. In one embodiment of the invention, the mobile device 200 is a mobile telephone. However, it should be understood that a mobile telephone is merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, mobile televisions, gaming devices, laptop computers, cameras, video recorders, audio/video player, radio, GPS devices, or any combination of the aforementioned.

The mobile device 200 generally includes a processor 210 communicably coupled to such devices as a memory 220, user output devices 236, user input devices 240, a network interface 260, a power source 215, a clock or other timer 250, a camera 280, and a positioning system device 275. The processor 210, and other processors described herein, generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like.

The processor 210 is configured to use the network interface 260 to communicate with one or more other devices on the network 120. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 122. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a payment network interface 270. The payment network interface 270 may include software, such as encryption software, and hardware, such as a modem, for communicating information to and/or from one or more devices on the payment network 124. For example, the mobile device 200 may be configured so that it can be used as a credit or debit card by, for example, wirelessly communicating account numbers or other authentication information to a POS terminal of the payment network 124 and/or merchant system 400.

As described above, the mobile device 200 has a user interface that is, like other user interfaces described herein, made up of user output devices 236 and/or user input devices 240. The user output devices 236 include a display 330 (e.g., a liquid crystal display or the like) and a speaker 232 or other audio device, which are operatively coupled to the processor 210. The user input devices 240, which allow the mobile device 200 to receive data from a user such as the consumer 110, may include any of a number of devices allowing the mobile device 200 to receive data from the user, such as a keypad, keyboard, touch-screen, touchpad, microphone, mouse, joystick, other pointer device, button, soft key, and/or other input device(s). The user interface may also include a camera 280, such as a digital camera.

The mobile device 200 also includes a positioning system device 275 that is configured to be used by the positioning system 150 to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a merchant or other location to determine that the consumer mobile device 200 is located proximate these known devices.

The mobile device 200 further includes a power source 215, such as a battery, for powering various circuits and other devices that are used to operate the mobile device 200. Embodiments of the mobile device 200 may also include a clock or other timer 500 configured to determine and, in some cases, communicate actual or relative time to the processor 210 or one or more other devices.

The mobile device 200 also includes a memory 220 operatively coupled to the processor 210. As used herein, memory includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement the functions of the mobile device 200 described herein. For example, the memory 220 may include such applications as a conventional web browser application 222 and/or a budget communication system client application 221. These applications also typically provide a graphical user interface (GUI) on the display 330 that allows the consumer 110 to communicate with the consumer mobile device 200, the budget communication system 500, and/or other devices. In one embodiment of the invention, when the consumer 110 decides to enroll in the budget communication program, the consumer 110 downloads the budget communication system client application 221 from the budget communication system 500. In other embodiments of the invention, the consumer 110 interacts with the budget communication system 500 via the web browser application 220 in addition to, or instead of, the budget communication system client application 221.

The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user preferences information 224 or budget information 226 related to one or more budget accounts or merchant gift cards.

The user preferences information 224 may include, for example, information used by the budget communication system 500 to determine the identity of the user, what type of budget information, purchasing trend(s), or merchant spending account (e.g., gift card) information the user wants to see, when the user would like to receive each type of information, how the user would like to receive each type information, when the user would like for the user's location to be available to the budget communication system 500, and/or the like. The user preference information 224 may be requested, for example, by the budget communication system client application 221 via the user output devices 236, and may be entered by the consumer 110 via the user input devices 240 and then stored by the processor 210 in the memory 220 and, in some cases, communicated to the budget communication system 500 via the network interface 260. In some embodiments, the user preferences include a digital certificate or other file used by the budget communication system 500 to identify and/or authenticate the consumer 110 associated with the mobile device 200 in a secure and/or encrypted way. Some examples of user preferences 224 are described in greater detail below with reference to the flow charts.

### Financial Management System

FIG. 3 provides a block diagram illustrating the financial management system 300 of FIG. 1 in more detail in accordance with an embodiment of the invention. The financial management system 300 generally includes a processor 310 communicably coupled to a communication interface 330 and a memory system 320. Like the processor 210 described with respect to FIG. 2, the processor 310 comprises the circuitry and logic to perform the various functions of the financial management system 300 described herein. The communication interface 330 includes a network interface 332 and a user interface 334, which may be similar to those described above with respect to FIG. 2. In one embodiment, the financial management system 300 is a computer system of a bank or other financial institution configured to process financial transactions (e.g., credit or debit card transactions and/or the like) for consumers and/or merchants having accounts with the bank or other financial institution.

According to various embodiments, the memory system 320 stores budget account data 321 related to one or more more budget accounts set up by the consumer 110 and consumer transaction data 322 related to one or more financial transactions made by the consumer 110 through the financial institution. The budget account data 321 includes a budget account name, an amount of money available to be spent within the budget account (e.g., spending balance), and credit and/or withdrawal rules associated with each budget account, according to various embodiments. In addition, in certain embodiments, the financial management system 300 provides systems and/or processes for assisting the consumer 110 with creating one or more budget accounts, such as the systems and processes described in U.S. application Ser. No. 12/821,631, entitled “Active Budget Control” and filed Jun. 23, 2010, which is herein incorporated by reference in its entirety.

Furthermore, financial institutions have access to large amounts of consumer data because they maintain or administer their customers' various financial accounts (e.g., credit card accounts, checking accounts, savings accounts, etc.) and because they have data related to their customers' purchases. Financial institutions track and store data related to the goods or services (e.g., “products”) that customers purchase, when their customers make their purchases, where the customers make their purchases, how much the customers spend, and/or the like, both for online and offline purchases. In addition, financial institutions have direct ties with many different merchants that use the financial institutions for their own financial needs. Accordingly, financial institutions are in a unique position to track consumer transaction data for purchases made by the consumer. In various embodiments, the consumer transaction data 322 includes information about one or more consumer transactions, such as transaction amount, date/time, location, merchant, products, transaction type, payment method, and/or the like. In addition, according to some embodiments, the financial system 300 may also track spending trends of the consumer 110 at one or more merchants over a particular time period (e.g., a week, month, quarter, year, etc.).

### Merchant System

FIG. 4 provides a block diagram illustrating the merchant system 400 of FIG. 1 in more detail in accordance with an embodiment of the invention. The merchant system 400 generally includes a processor 410 communicably coupled to a communication interface 430 and a memory system 420. Like the processor 210 described with respect to FIG. 2, the processor 410 comprises the circuitry and logic to perform the various functions of the merchant system 400 described herein. The communication interface 430 includes a network interface 432 and a user interface 434, which may be similar to those described above with respect to FIG. 2.

The memory system 420 may include a web browser application 422 and/or a budget communication system client application 421 which comprise computer-executable instructions/code executed by the processor 410 to implement at least some of the functions of the merchant system 400 described herein. These applications also typically provide a graphical user interface (GUI) on the user interface 434 that allows a merchant representative to communicate with the budget communication system 500 and/or other devices. In one embodiment of the invention, a merchant representative downloads the budget communication system client application 421 from the budget communication system 500. In other embodiments of the invention, the merchant interacts with the budget communication system 500 by using the web browser application 220 to access and log into a website of the budget communication system 500. The merchant may use these applications to enroll in the budget communication system 500 and to communicate (or update) gift card balances and/or merchant preferences for the budget communication system 500. The memory system 420 may also include consumer transaction data 424 and/or spending account (e.g., gift card) balances 423 stored therein.

In some embodiments, the merchant system 400 tracks consumer transaction data 424 for consumers doing business with the merchant. In certain embodiments of the invention, the consumer transaction data 424 is communicated to the budget communication system 500 for providing spending trend information to the consumer 110 and/or for determining how budget information should be presented to the consumer's mobile device. In some instances, this information is provided in real time or substantially real time relative to when the transaction between the consumer 110 and the merchant actually occurs.

The merchant system 400 may also include, in some embodiments, one or more positioning system devices 470, such as one or more proximity sensors for sensing a consumer mobile device 200 entering or leaving the merchant's location. For example, in one embodiment of the invention, the merchant has one or more sensors/transceivers located at the entrances and exits to the merchant's location that are configured to detect when a consumer 110 going through the entrance or exit holding a mobile device 200 that is configured to communicate a consumer identifier to the sensors/transceivers. The consumer location information gathered by the positioning system devices 470 is then communicated to the budget communication system 500 so that the budget communication system 500 knows whether the consumer 110 is at, entering, or exiting the merchant facility. In other embodiments of the invention, the merchant may be mobile and, as such, some embodiments of the positioning devices 470 are GPS devices indicating the location of the merchant so that the budget communication system 500 can determine the merchant's location relative to the location of one or more consumers. It will be appreciated that, in some embodiments of the invention, the merchant system 400 does not have any positioning system devices 470 since, for example, a GPS system or a similar system not associated with the merchant system 400 may be used to determine the location of the consumer 110, while the merchant locations may already be known and stored in the memory of the budget communication system 500.

### Budget Communication System

FIG. 5 provides a block diagram illustrating the budget communication system 500 of FIG. 1 in more detail in accordance with an embodiment of the invention. The budget communication system 500 generally includes a processor 510 communicably coupled to a communication interface 530 and a memory system 520. Like the processor 210 described above with respect to FIG. 2, the processor 510 comprises the circuitry and logic to perform the various functions of the budget communication system 500 described herein. The communication interface 530 includes a network interface 532 and a user interface 534, which may be similar to those described above with respect to FIG. 2. The memory system 520 includes a budget communication system application 521 including computer-executable processor code that instructs the processor 510 to perform the various functions described herein as being performed by the budget communication system 500. The memory system 520 also includes merchant and consumer location data 525, consumer transaction data 524, consumer preference data 522, and budget account data 523 stored therein.

The merchant and consumer location data 525 includes location data for each of a plurality of merchants and each of a plurality of participating consumers 110. According to various embodiments, the merchant location data may be determined by public directories containing addresses of various merchants, from the merchant system 400 for some merchants, from the positioning system 150, the financial management system 300, and/or other systems or entities that provide addresses or other location information for one or more merchants. The consumer location data is received from the positioning system 150, which as described above, determines the consumer's current location and/or travel history by tracking the position of the consumer's mobile device 200 over time.

The consumer transaction data 524 includes information about one or more consumer transactions, such as transaction amount, time, location, merchant, products, transaction type, coupons used, payment method, and/or the like. The budget communication system 500 may receive the consumer transaction data 524 from the financial management system 300, the merchant system 400, the consumer mobile device 200, and/or other systems. In some embodiments of the invention, the budget communication system application 521 (when executed by the processor 510) maps the consumer transaction data 524 against the merchant and consumer location data 525 by, amongst other things, correlating the time of each consumer transaction with the consumer's location at that time and by comparing the consumer's location with the locations of a plurality of merchants. In this way, spending trends are identified for each consumer 110.

The consumer preference data 522 may include, for example, information used by the budget communication system 500 to determine the type(s) of budget account(s) or spending account(s) (e.g., gift cards) for which the consumer 110 may be interested in viewing budget information, when the consumer 110 would like to receive budget information, how the consumer 110 would like to receive budget information, the merchant or type(s) of merchant(s) for which the consumer 110 would like to receive spending trend information, when the consumer 110 would like for the consumer's location to be tracked by the budget communication system 500, the particular distance range between the consumer mobile device and the merchant location when budget or spending trend information should be communicated to the mobile device 200, and/or the like. The consumer preference data 522 may be, for example, consumer-generated and received from the consumer mobile device 200. The consumer preference data 522 may also be determined by the budget communication system 500 automatically and/or based on trends identified in the consumer transaction data 524. Some examples of consumer preference data 522 are described in greater detail below with reference to the flow charts shown in FIGS. 6 through 8.

The budget account data 523 may include, for example, for each budget and/or spending account: a budget balance amount, a merchant or type(s) of merchant(s) associated with the budget account, merchant category code(s) associated with the budget account, and a budget account name. In some embodiments, at least a portion of the budget account data 523 is provided to the budget communication system 500 from the financial management system 300, and in other embodiments, the budget account data 523 is provided directly to the budget communication system 500. Some examples of budget account data 523 are described in greater detail below with reference to FIG. 6 through 11.

### Exemplary Position-Based Budget Communication Processes

FIG. 6 provides a flow chart illustrating a position-based budget communication process 600 in accordance with an embodiment of the invention. As represented by block 602, the consumer 110 downloads the budget communication system client application 221 to the consumer's mobile device 200. In one embodiment, the consumer uses the web browser application 222 and the network interface 260 of the mobile device 200 to connect to the budget communication system 500 over the network 120 to download to the budget communication system client application 221 from the budget communication system 500. For example, where the budget communication system 500 is maintained by or otherwise associated with a financial institution, the consumer 110 may use the mobile device 200 to connect to the financial institution's mobile banking website on the Internet and then download the budget communication system client application 221. In other embodiments, the budget communication client application 221 comes pre-installed on the mobile device 200 or is stored on the mobile device 200 in other ways. In still other embodiments of the invention, a budget communication system client application 221 is not required and, instead, the budget communication system 500 utilizes standard hardware and software applications of the mobile device 200, such as a standard web browser application 222, to communicate with the consumer 110 and/or perform the other functions of the mobile device 200.

As represented by block 604, the consumer 110 then initiates a shopping event, thereby activating the location tracking feature of the budget communication system client application 221 and/or budget communication system application 521. For example, in one embodiment, the consumer 110 initiates a shopping event by, for example, using the user interface of the mobile device 200 to activate the budget communication system client application 221 and its tracking features. In other embodiments, the budget communication system client application 221 is always running, running on a schedule, or activated in other ways. In some embodiments, the consumer 110 must be authenticated, via, for example a username and password, by the budget communication system 500 and/or the budget communication system client application 221 before personalized budget information is displayed on the consumer mobile device 200. In other embodiments of the invention, authentication is not required.

As represented by block 606, the budget communication system application 521 receives the consumer's mobile device's 200 location information. For example, in one embodiment of the invention, the positioning system 150 determines the location of the consumer's mobile device 200 relative to the world or other geography (e.g., via a GPS system or similar system). In another example embodiment, proximity sensors are located proximate to one or more merchants, and these sensors can determine when the consumer mobile device 200 is visiting, approaching, and/or leaving the one or more merchants. For example, participating merchants may install sensors at each entrance and exit of the merchant location and determine that a consumer 110 is visiting the merchant location by sensing the positioning system device 275 of the consumer mobile device 200 when the consumer 110 walks through an entrance with the consumer mobile device 200. In such an embodiment, the budget communication system 200 may determine that the consumer 110 is leaving the merchant location by either having dedicated exits, by determining the proximity of the consumer mobile device 200 to an exit, or by determining that the consumer 110 must be exiting if the consumer mobile device 200 is sensed in an entrance/exit after being sensed when the consumer 110 entered the merchant location. In another embodiment of the invention, the consumer mobile device 200 has a sensor configured to sense transmitters or other devices located proximate one or more merchants (e.g., at the entrances and exits of the merchant's location) and then communicates the sensed information to the budget communication system 500.

Then, as represented by block 608, the budget communication system 500 identifies a merchant that is located within a particular distance range of the consumer's mobile device 200. According to various embodiments, for example, the budget communication system 500 compares the consumer's mobile device's 200 location to the known location (e.g., address) of one or more merchants. For example, in one embodiment, the budget communication system 500 utilizes a database storing merchant locations to determine which merchant locations are within the particular distance range of the consumer's mobile device 200. According to some embodiments, the particular distance range is between 0 and about 200 feet, and in one embodiment, the particular distance range is between 0 and about 50 feet. In yet another embodiment, the particular distance range is less than about 50 feet. In other embodiments, the distance range may include other distances (e.g., one mile, a half mile, a quarter kilometer, etc.). The particular distance range, according to various embodiments, is set by the consumer 110 via the budget communication system client application 221 and is stored as consumer preference data 522. Some embodiments of the system may have a distance range of zero and require that the consumer enter the merchant location.

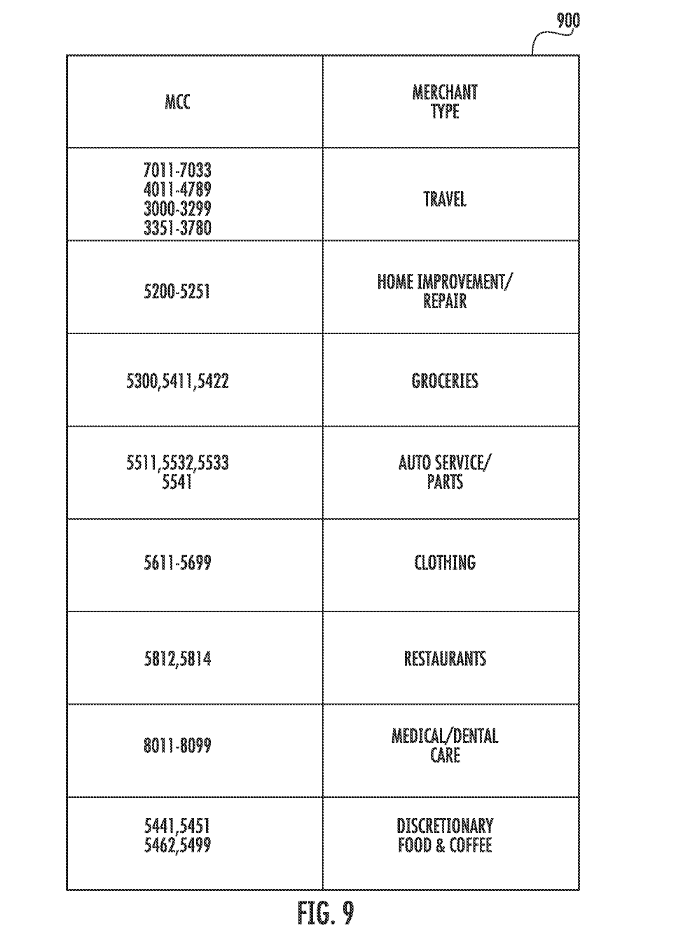

Next, as represented by block 610, the budget communication system 500 identifies a category associated with the merchant identified in block 608 as being within the particular distance range of the consumer's mobile device 200. In various embodiments, the category may be related to a product type or a merchant type. For example, according to certain embodiments, the merchant type is based at least in part on the merchant category code (MCC) associated with the merchant. A listing of MCCs for various merchants can be found at http://www.mrsc.org/govdocs/p58mcc_codes.pdf, which is herein incorporated by reference in its entirety. According to certain embodiments, the budget communication system 500 stores a table listing various MCCs and a merchant type associated with each MCC as budget account data 523. An exemplary table 900 according to one particular embodiment is shown in FIG. 9, which indicates, for example, that MCCs within the ranges of 3000-3299, 3351-3780, 4011-4789, and 7011-7033 correspond to travel merchant types, and MCCs within the range of 5200-5251 correspond to home improvement/repair merchant types.

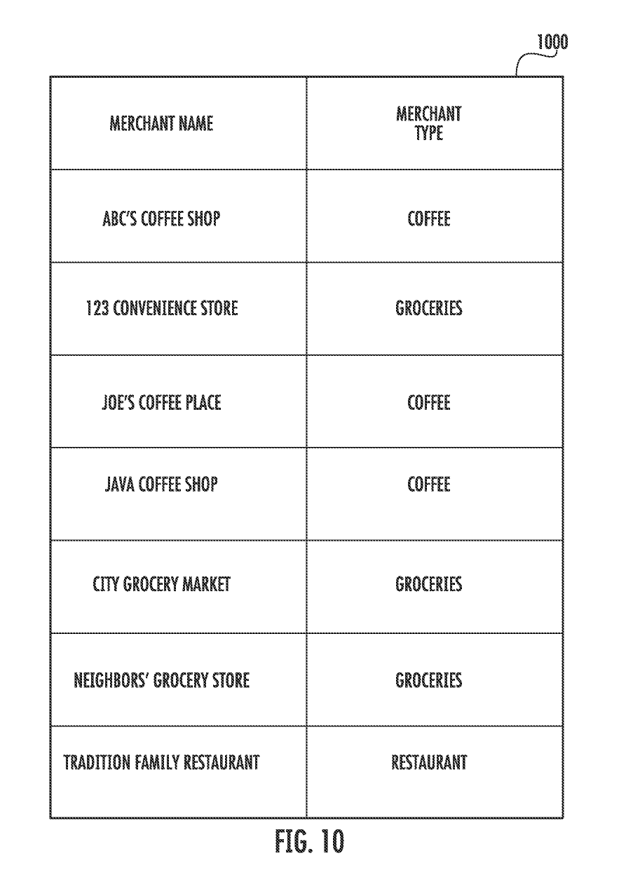

However, some MCCs may not be sufficiently specific to allow the system 500 to identify merchant types that correspond with some of the budget accounts set up by the consumer 110, such as, for example, a “coffee” or a “work clothing” budget account. In addition, some merchants may sell different types of items (e.g., groceries and prepared meals), and the consumer 110 may wish to specify which budget account (e.g., grocery or restaurant) should be associated with the particular merchant. To accommodate such situations, according to one embodiment, the budget communication system 500 stores one or more MCC-specific tables that list names of one or more merchants assigned a specific MCC and a merchant type associated with each merchant. An exemplary MCC-specific table 1000 according to one particular embodiment is shown in FIG. 10, which lists the merchant names of various merchants having an MCC of 5499 (Misc. Food Stores—Convenience Stores and Specialty Markets). In addition, according to other embodiments, the system 500 stores one or more tables (not shown) that are not MCC-specific but that list the names of one or more merchants and the merchant type (or types) associated with each merchant.

In certain embodiments, the merchant name tables discussed above may be set up by the consumer 110 via the budget communication client application 221 and/or 521 or through the financial management system 300. In other embodiments, the merchant tables may be set up by the financial institution initially, and the consumer 110 may modify the tables. In addition, according to one embodiment, the tables include merchants that are located within a certain distance range (e.g., about 25 to about 50 miles) of the consumer's home and/or work address.

As shown in block 612, the budget communication system 500 then retrieves from the budget account data 523 stored in the memory 520 budget information associated with the consumer and the merchant. According to various embodiments, the budget information is associated with a budget, and the budget is associated with the category identified in block 610. In certain embodiments, the budget is a consumer-defined amount of money available to be spent within the category over a particular time period, and in a particular embodiment, the budget information is associated with a budget account that is associated with the category.

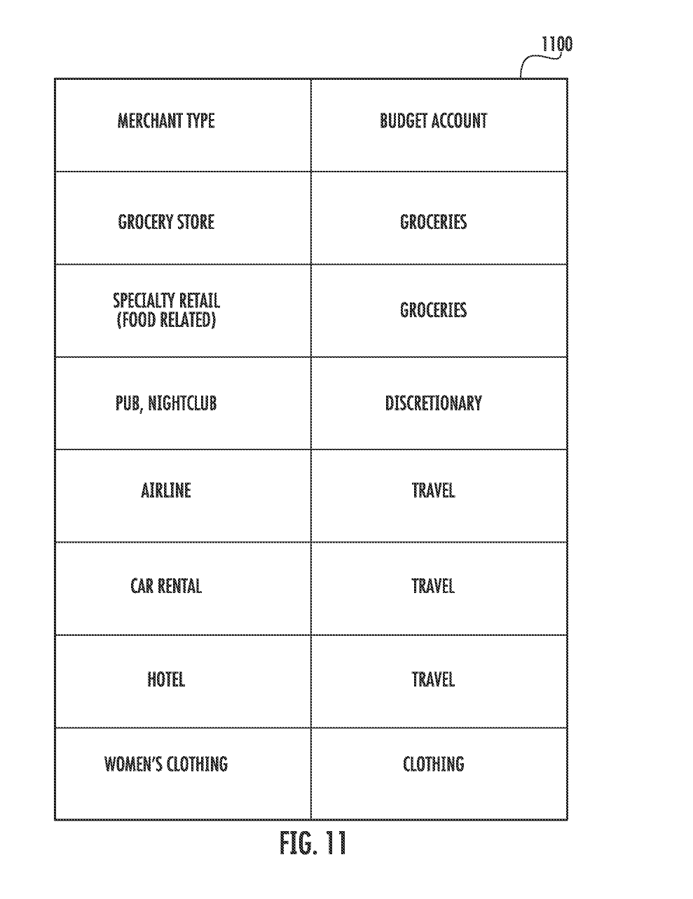

According to various embodiments, the category corresponds to a merchant type. For example, in certain embodiments, the budget communication system 500 stores one or more tables listing merchant types and the corresponding budget account, such as the table 1100 shown in FIG. 11. In addition, according to various embodiments, the budget information retrieved includes, for example, how much has been spent during a certain time period (e.g., month, week) on purchases associated with the budget account, the budget account balance, and the budget account name.

Next, as shown in block 614, the budget communication system 500 communicates at least a portion of the budget information to the consumer's mobile device 200 via the network 120, and in block 616, the budget communication system client application 221 on the consumer's mobile device 200 causes the communicated budget information to be displayed on the mobile device 200. According to various embodiments, at least the budget account name, the account balance, and the amount spent during a certain time period is communicated to the consumer's mobile device 200 and is caused to be displayed thereon. However, in other embodiments, only the budget account name and the account balance are communicated to the consumer's mobile device 200. In various embodiments, the type of budget information to be communicated to the consumer 110 is set by a manager of the budget communication system 500 or the consumer 110. And, in a particular embodiment, the type of budget information to be communicated to the consumer 110 is initially set by the manager of the budget communication system 500, and the consumer 110 may then make adjustments via the budget communication system client application 221 and/or 521.

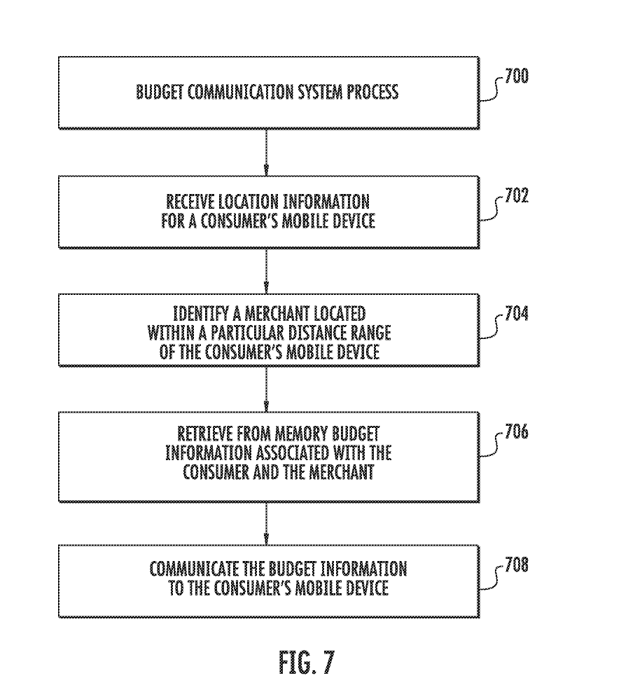

FIG. 7 illustrates a process 700 of communicating balance information associated with a spending (e.g., a gift card) and/or budget account to the consumer's mobile device 200. The process 700 illustrated in FIG. 7 is similar to process 600 described above in relation to FIG. 6, but in process 700, the budget communication system 500 does not necessarily identify a category associated with the merchant as shown in block 610. In particular, beginning with block 702, the budget communication system 500 receives location information for the consumer's mobile device 200. Then, in block 704, the system 500 identifies a merchant located within a particular distance range of the consumer's mobile device 200. Next, at block 706, the system 500 retrieves budget information associated with the consumer and the merchant. Finally, at block 708, the system 500 communicates the budget information to the consumer's mobile device 200.

Referring back to block 706, according to various embodiments, the budget information may include, for example, information about an amount of money available in a spending account (e.g., a gift card) that is held by the consumer 110 and can be used for purchases from the merchant (or an entity affiliated with the merchant), information about an amount of money that the consumer 110 has spent at the merchant within a particular period of time, or information about a balance of a budget account set up by the consumer 110 that is associated with a category associated with the merchant. According to various embodiments, if the spending account corresponds to a gift card, the budget information associated with the gift card is stored in the memory 520 of the budget communication system 500 or in the memory 420 of the merchant system 400. Similarly, according to various embodiments, if the budget information includes information about the balance of the budget account set up by the consumer 110 through the financial management system 300, the balance information is stored in the memory 520 of the budget communication system 500 or the memory 320 of the financial management system 300.

According to certain embodiments, the budget communication system 500 also monitors the budget information, and in particular, a spending balance (not shown). For example, in one embodiment of the invention, the budget communication system 500 is in constant or frequent communication with the financial management system 300 and/or the merchant system 400. When, for example, the consumer 110 makes a purchase using a merchant-issued gift card, the merchant system 400 receives information about the transaction, and when the consumer makes a purchase using a payment device issued or authorized by the financial institution (e.g., a credit card or debit card, check, etc.), the financial management system 300 receives information about the transaction via, for example, a request to authorize the financial component of the transaction. The transaction information is then communicated to the budget communication system 500 in real time or substantially real time, according to some embodiments. In this way, the budget communication system 500 can update quickly (e.g., in real time or substantially real time) spending or budget account balances associated with the merchant from which a purchase was made. In other embodiments, the budget communication system receives information about the purchase from the consumer mobile device 200 instead of or in addition to from the financial management system 300 or the merchant system 400.

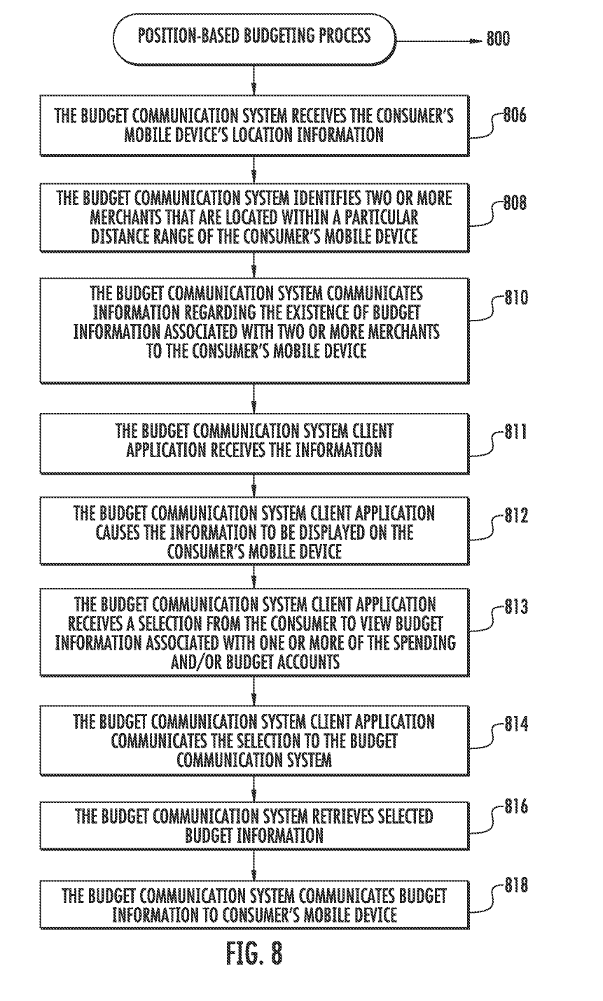

FIG. 8 illustrates a process 800 of communicating budget information associated with at least one spending or budget account to the consumer mobile device 200. The process 700 illustrated in FIG. 8 is similar to the processes 600, 700 described above in relation to FIGS. 6 and 7, respectively, but in process 800, the budget communication system 500 identifies two or more merchants and communicates information regarding the existence of budget information associated with the two or more merchants to the consumer's mobile device 200. In particular, beginning with block 806, the budget communication system 500 receives location information for the consumer's mobile device 200. Then, in block 808, the system 500 identifies two or more merchants located within a particular distance range of the consumer's mobile device 200. Next, at block 810, the system 500 communicates to the consumer's mobile device 200 information regarding the existence of budget information associated with the two or more merchants. According to a particular embodiment, the system 500 communicates a list of budget and/or spending accounts associated with the two or more merchants to the consumer's mobile device 200. For example, if one merchant is associated with a grocery budget account and two merchants are associated with a travel budget account, the system 500 communicates a list indicating that merchants nearby are associated with the consumer's grocery and travel budgets. In addition, according to one embodiment, the system 500 may also communicate the number of nearby merchants that are associated with each spending account.

Next, the budget communication system client application 221 receives the information communicated in block 810 (block 811), causes the information to be displayed to on the consumer's mobile device 220 (block 812), receives a selection from the consumer 110 to view the budget information associated with one or more of the spending and/or budget accounts (block 813), and communicates the selection to the budget communication system 500 (block 814). For example, according to various embodiments, the client application 221 causes a check box or radio button to be displayed next to each spending and/or budget account listed, and the consumer 110 selects, using this interface, the account(s) the consumer wishes to view. In other embodiments, the client application 221 only allows the consumer 110 to select one spending or budget account to view at a time.

Then, at block 816, the budget communication system 500 receives the selection and retrieves from memory 520 (e.g., budget account data 523) budget information associated with the selected spending and/or budget account(s), and in block 818, the retrieved budget information is communicated to the consumer's mobile device 200.

According to other embodiments (not shown), the budget communication system 500 selects the spending and/or budget account(s) for which budget information is communicated to the consumer's mobile device 200 based at least in part on the consumer's transaction data 524. In yet another embodiment, the system 500 selects the spending and/or budget account(s) based at least in part on consumer preference data 522 indicating which spending and/or budget account(s) should be given a certain priority.

And, in yet another embodiment (not shown), the system 500 updates the budget information communicated to the consumer's mobile device 200 based on whether the consumer 110 and the mobile device 200 are within the store of a particular merchant or are exiting the store. For example, the system 500 communicates budget information associated with one particular merchant when the system 500 determines that the consumer 110 is entering or is located within the particular merchant's store using the positioning system 150 in conjunction with the consumer's mobile device 200. As described above, this determination may be made using a GPS or similar system that identifies the location of the consumer mobile device 200 generally, and/or using a proximity sensor system proximate the merchant's store that identifies whether the consumer mobile device 200 is in close proximity to the merchant's store or has entered the merchant's store. For example, in one embodiment of the invention, the positioning system 150 determines that the consumer 110 walks into an electronics store by identifying the consumer's mobile device 200 within the store. After some time, the budget communication system 500 senses the consumer's mobile device 200 going through an exit of the electronic store and, determines based on this information, that the consumer 110 is leaving the electronics store. In response, the system 500 updates the budget information communicated to the consumer's mobile device 200 to include the budget information associated with other nearby merchants but not the budget information associated with the electronics store.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s). The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. An position-based budget communication apparatus for use in a position-based budgeting system, whereby the apparatus communicates budget information in real-time based on geographical positioning determinations and consumer preferences, the apparatus comprising:
an electronic storage device memory;
a positioning system configured to determine location information for a consumer's mobile device wherein the location information for the consumer's mobile device comprises information about interaction between the consumer's mobile device and an electronic device located proximate to a merchant area;
one or more computing processors;
a position-based budgeting module stored in the electronic storage device memory, said module comprising instruction code executable by one or more computing processors, and configured to cause the one or more computing processors to:
store, in memory, consumer preference data, wherein the consumer preference data specifies (1) the type of budget information the consumer prefers to receive via communication to the consumer's mobile device and (2) one or more times when the consumer prefers to receive the budget information via communication to the consumer's mobile device, and wherein at least a portion of the consumer preference data is automatically determined based on trends identified in the consumer's transaction data;
use the location information to instantaneously determine that the consumer's location is within a predetermined distance range from the merchant associated with the merchant area; and
electronically retrieve, from a memory, budget information associated with the consumer and the merchant wherein the budget information associated with the consumer and the merchant comprises information about an amount of money that the consumer has spent at the merchant within a particular period of time; and
an electronic communication system configured to electronically communicate at least a portion of the budget information to the consumer's mobile device, the at least a portion of the budget information being displayable thereon wherein the at least a portion of the budget information is communicated based at least partially on determining the merchant area is located proximate to the consumer's mobile device and the consumer preference data, wherein the at least portion of the budget information includes the type of budget information the consumer prefers to receive via communication to the consumer's mobile device, and wherein the at least portion of the budget information is communicated at the one or more times when the consumer prefers to receive the budget information via communication to the consumer's mobile device.

2. The apparatus of claim 1, wherein the budget information associated with the consumer and the merchant comprises:
information about an amount of money available on a gift card that is held by the consumer and can be used at the merchant.

3. The apparatus of claim 1, wherein the computer system is configured to retrieve budget information associated with the consumer and the merchant by:
identifying a category associated with the merchant; and
retrieving, from the memory, budget information associated with a budget, the budget being associated with the category.

4. The apparatus of claim 3, wherein the budget comprises a consumer-defined amount of money available to be spent within the category over a particular period of time.

5. The apparatus of claim 3, wherein the budget information comprises a balance associated with the budget.

6. The apparatus of claim 3, wherein the category comprises a product type.

7. The apparatus of claim 3, wherein the category comprises a merchant type.

8. The apparatus of claim 1, wherein the budget information associated with the consumer and the merchant comprises:
balance information associated with a spending account, the spending account being associated with the merchant.

9. A position-based budget communication computer-implemented method for use in a position-based budgeting system, whereby the computer-implemented method provides for communicating budget information in real-time based on geographical positioning determinations and consumer preferences, the computer-implemented method comprising:
storing, in memory using a computing processor device, consumer preference data, wherein the consumer preference data specifies (1) the type of budget information the consumer prefers to receive via communication to the consumer's mobile device and (2) one or more times when the consumer prefers to receive the budget information via communication to the consumer's mobile device, and wherein at least a portion of the consumer preference data is automatically determined based on trends identified in the consumer's transaction data;
electronically receiving, via a computing processor device, location information for the consumer's mobile device wherein receiving location information for the consumer's mobile device comprises receiving information about interaction between the consumer's mobile device and an electronic device located proximate to a merchant area;
instantaneously identifying, using a computing processor device, the merchant associated with the merchant area that is located within a particular distance range of the consumer's mobile device;
electronically retrieving, from a memory, budget information associated with the consumer and the merchant wherein the budget information associated with the consumer and the merchant comprises information about an amount of money that the consumer has spent at the merchant within a particular period of time; and
electronically communicating, using a computing processor device, at least a portion of the budget information to the consumer's mobile device, the at least a portion of the budget information being displayable thereon wherein the at least a portion of the budget information is communicated based at least partially on determining the merchant area is located proximate to the consumer's mobile device and the consumer preference data, wherein the at least portion of the budget information includes the type of budget information the consumer prefers to receive via communication to the consumer's mobile device, and wherein the at least portion of the budget information is communicated at the one or more times when the consumer prefers to receive the budget information via communication to the consumer's mobile device.

10. The computer-implemented method of claim 9, wherein the budget information associated with the consumer and the merchant comprises:
information about an amount of money available on a gift card that is held by the consumer and can be used at the merchant.

11. The computer-implemented method of claim 9, wherein retrieving budget information associated with the consumer and the merchant comprises:
identifying a category associated with the merchant; and
retrieving, from the memory, budget information associated with a budget, the budget being associated with the category.

12. The computer-implemented method of claim 11, wherein the budget comprises a consumer-defined amount of money available to be spent within the category over a particular period of time.

13. The computer-implemented method of claim 11, wherein the budget information comprises a balance associated with the budget.

14. The computer-implemented method of claim 11, wherein the category comprises a product type.

15. The computer-implemented method of claim 11, wherein the category comprises a merchant type.

16. The computer-implemented method of claim 15, wherein the merchant type corresponds to a merchant category code.

17. The computer-implemented method of claim 15, wherein the merchant type corresponds to a merchant category code, and identifying the merchant type further comprises:
identifying a name of the merchant from a list of one or more merchant names associated with the merchant category code; and
retrieving a merchant type associated with the name of the merchant from a merchant type list.

18. The computer-implemented method of claim 15, wherein identifying the merchant type further comprises:
identifying a name of the merchant; and
retrieving a merchant type associated with the name of the merchant from a merchant type list.

19. The computer-implemented method of claim 9, wherein receiving location information for the consumer's mobile device comprises receiving location information from a global positioning system.

20. The computer-implemented method of claim 9, wherein the particular distance range is between 0 feet and about 200 feet.

21. The computer-implemented method of claim 9, wherein the particular distance range is less than about 50 feet.

22. The computer-implemented method of claim 9, wherein the particular distance range is defined by the consumer.

23. The computer-implemented method of claim 9, wherein the particular distance range is zero and identifying the merchant that is located within the particular distance range of the consumer's mobile device comprises identifying when the consumer's mobile device enters the merchant's facility.

24. The computer-implemented method of claim 9, wherein retrieving budget information associated with the consumer and the merchant comprises:
identifying a category associated with the merchant; and
retrieving, from the memory, budget information associated with a budget account, the budget account being associated with the category.

25. The computer-implemented method of claim 9, wherein the budget information comprises a balance associated with the budget account.

26. The computer-implemented method of claim 9, wherein the budget information associated with the consumer and the merchant comprises:
balance information associated with a spending account, the spending account being associated with the merchant.

27. The computer-implemented method of claim 26 wherein the spending account corresponds to a gift card issued by the merchant, and the balance information comprises a spending balance for the gift card.

28. The computer-implemented method of claim 9, further comprising:
identifying at least a first merchant and a second merchant that are located within a particular distance range of the consumer's mobile device;
retrieving, from a memory, first budget information associated with the first merchant and second budget information associated with the second merchant;
communicating information regarding existence of the first budget information and the second budget information to the consumer's mobile device;
in response to receiving a selection from the consumer's mobile device to view the first budget information, communicating at least a portion of the first budget information to the consumer's mobile device, the at least a portion of the first budget information being displayable thereon; and
in response to receiving a selection from the consumer's mobile device to view the second budget information, communicating at least a portion of the second budget information to the consumer's mobile device, the at least a portion of the second budget information being displayable thereon.

29. A position-based budget communication computer program product for a position-based budgeting system, whereby the computer program product provides for communicating budget information in real-time based on geographical positioning determinations and consumer preferences, the computer program product comprising:
at least one non-transitory computer-readable medium having computer-executable code portions embedded therein, the computer-executable program code portions comprising:
a first executable portion configured for causing a computer to store consumer preference data, wherein the consumer preference data specifies (1) the type of budget information the consumer prefers to receive via communication to the consumer's mobile device and (2) one or more times when the consumer prefers to receive the budget information via communication to the consumer's mobile device, and wherein at least a portion of the consumer preference data is automatically determined based on trends identified in the consumer's transaction data;
a second executable portion configured for causing a computer to electronically receive location information for the consumer's mobile device wherein receiving location information for the consumer's mobile device comprises receiving information about interaction between the consumer's mobile device and an electronic device located proximate to a merchant area;
a third executable portion configured for causing a computer to instantaneously identify the merchant associated with the merchant area that is located within a particular distance range of the consumer's mobile device;
a fourth executable portion configured for causing a computer to electronically retrieve, from a memory, account information associated with a budget that relates to the merchant and the consumer wherein the budget information associated with the consumer and the merchant comprises information about an amount of money that the consumer has spent at the merchant within a particular period of time; and
a fifth executable portion configured for causing a computer to electronically communicate at least a portion of the account information to the consumer's mobile device, the at least a portion of the account information being displayable thereon wherein the at least a portion of the budget information is communicated based at least partially on determining the merchant area is located proximate to the consumer's mobile device and the consumer preference data, wherein the at least portion of the budget information includes the type of budget information the consumer prefers to receive via communication to the consumer's mobile device, and wherein the at least portion of the budget information is communicated at the one or more times when the consumer prefers to receive the budget information via communication to the consumer's mobile device.
